(19) United States
(12) Patent Application Publication
(10) Pub. No.: US 2018/0121841 A1
(43) Pub. Date: May 3, 2018

(54) COMPUTER-BASED END-TO-END PROCESS MODELER FOR DESIGNING AND TESTING BUSINESS PROCESSES

(71) Applicant: ThinkProcess Inc., Chester Springs, PA (US)

(72) Inventor: Arthur Harris, Chester Springs, PA (US)

(21) Appl. No.: 15/797,825

(22) Filed: Oct. 30, 2017

Related U.S. Application Data
(60) Provisional application No. 62/414,338, filed on Oct. 28, 2016.

(51) Int. Cl. G06Q 10/06

(52) U.S. Cl. CPC G06Q 10/067

(57) ABSTRACT

A system for performing end-to-end process modeling includes a business process repository, a design toolset editor, and an implementation toolset. The business process repository stores a plurality of predefined best practice processes. The design toolset editor is configured to design a business process by altering one of the plurality of best practices processes to match a business requirement. The design toolset editor displays processes and flow connectors as graphical objects. The implementation toolset is configured to generate an executable process from the business process. The implementation toolset comprises an implementation toolset interface configured to enable implementation of changes to underlying code of the processes necessitated by the changes made in the design toolset editor.

### CROSS REFERENCE TO RELATED APPLICATIONS

This application claims the benefit of U.S. Provisional Application Ser. No. 62/414,338, filed Oct. 29, 2016, which is incorporated herein by reference in its entirety.

### TECHNICAL FIELD

The present invention relates generally to computer-based methods, systems, and apparatuses related to a business process modeling. The technology described herein may be applied, for example, to automate the creation and maintenance of process modeling activities via a computer-based tool.

### BACKGROUND

In general, processes followed within an organization's ecosystem are described in various forms in most enterprise environments. This type of modeling is becoming increasingly important, as companies attempt to create uniform processes across the enterprise.

Process modeling typically requires the use of many distinct tools. For example, tools such as ARIS™ or Visio™ may be employed for process modeling. Then, a tool such as HP Quality Center™ may be used for testing and additional tools may be used for managing projects. For example, in some organizations, documentation of the business process design is also managed in Microsoft Word™ documents. The lack of integration between these tools results in an overall lack of efficiency in process modeling. For example, data may not be readily transferrable between tools or the process of transferring data may be unwieldy. Moreover, the multiple tools discussed above are typically designed by different vendors. As a result, the interfaces and other aspects of using each tool are typically distinct and a user is required to master each different tool.

Accordingly, it is designed to integrate design and testing business processes to enhance modeling activities.

### SUMMARY

Embodiments of the present invention address and overcome one or more of the above shortcomings and drawbacks, by providing methods, systems, and apparatuses related to the use of an integrated method for designing and testing business processes. More specifically, a computer-based end-to-end process modeler is described herein that comprises a vertically integrated process modeler. This modeler provides a design aspect for a non-technical user and an implementation aspect for a technical user. The vertically integrated process modeler is designed to create a complete executable process. In using the techniques described herein, a business analyst that is assigned to develop a business process will use the end-to-end process modeler to document all aspects of the process design. The business analyst will also develop a portion of the process framework, and process flow diagrams in the end-to-end process modeler. Test plans with the steps to test the new process will then be created and executed. Project management resources are tracked, along with the progress of design and testing in the end-to-end process modeler.

According to some embodiments of the present invention, a system for performing end-to-end process modeling includes a business process repository, a design toolset editor, and an implementation toolset. The business process repository stores a plurality of predefined best practice processes. The design toolset editor is configured to design a business process by altering one of the pluralities of best practices processes to match a business requirement. In one embodiment, the design toolset editor further includes predefined functionalities from the plurality of predefined best practices processes, the predefined functionalities available to the design toolset editor for insertion into the business process. The design toolset editor displays processes and flow connectors as graphical objects. The implementation toolset in the system is configured to generate an executable process from the business process. The implementation toolset comprises an implementation toolset interface configured to enable implementation of changes to underlying code of the processes necessitated by the changes made in the design toolset editor. In one embodiment, the system further includes an implementation toolset integration tool configured to integrate the business process with an external system.

Some embodiments of the aforementioned system further include a drill-down logic module that drills down to a sub-process and to steps of the sub-process, wherein said drilling down enables displaying and editing of the steps of the sub-process.

Some embodiments of the system include a check-in logic module configured to receive the business process from the design toolset editor and to pass the business process to the implementation toolset interface for implementation. Additionally, the system may include a flagging logic module configured to flag one or more elements in the business process that require attention during implementation. This flag may signify, for example, a type of modification to be performed during implementation. Additionally, the system may include a collection of processes in progress available to the implementation toolset interface for editing. This collection of processes may include, for example, completed business processes finished using the design toolset editor.

According to other embodiments, a computer-implemented method for performing end-to-end process modeling include retrieving a business process model associated with a predefined best practice process from a business process repository and displaying the business process model in an interactive graphical user interface. The business process model is modified via the graphical user interface based on one or more business requirements. This modification may include, for example, modifying the business process model includes adding one or more new processes to the business process model. In one embodiment, the new processes are added between one or more numbered processes in the business process model. Following addition of the new processes, all processes in the business process model may be renumbered. The method may further include generating a computer-executable process generated from the modified business process model.

In some embodiments of the aforementioned method, the business process model comprises a plurality of levels and modifying the business process model includes attaching business process collateral elements to one or more of the levels. The method may further include storing the business process collateral elements in the business process repository.

Additionally, in one embodiment, the method further includes receiving a request for listing of business process collateral elements associated with a particular business process, and querying the business process repository to retrieve the listing of business process collateral elements associated with the particular business process. Then, a graphical representation of the listing of business process collateral elements in response to the request may be presented.

In other embodiments, the aforementioned method includes determining one or more process activities included in the business process model and populating a flow diagram canvas based on the one or more process activities. The flow diagram canvas is displayed in the graphical user interface. Process flow diagrams are created based on user interaction with the flow diagram canvas via the graphical user interface.

According to other embodiments, a system for performing end-to-end process modeling includes a business process repository comprising a plurality of business process models, and a process design module presenting one or more graphical user interface for modifying the business process models. The system further includes a test case generator that creates business process test cases from the business process models.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1 is a diagram of one embodiment of a typical software implementation project;

FIG. 2 illustrates a computer-based end-to-end process modeler, according to some embodiments;

FIG. 3 is a block diagram of one embodiment of the high level architecture, showing the process model as the foundation of some embodiments of the invention;

FIG. 4 is a flowchart of one embodiment of the design sequence a business analyst would follow to design a new process;

FIG. 5 is a flowchart of one embodiment of the process to follow for creating test scripts from the design content;

FIG. 6 is a flowchart of one embodiment of the process to follow for creating test scripts from the process model;

FIG. 7 illustrates one embodiment of the automatic creation of process flow diagrams from the process model;

FIG. 8 illustrates one embodiment of how multiple process models are loaded from an external data source;

FIG. 9 illustrates embodiments of how multiple design documents are created at level 4 of the process model;

FIG. 10 illustrates all the design elements that must be completed during the design phase of a software implementation; and

FIG. 11 illustrates an exemplary computing environment within which embodiments of the invention may be implemented.

### DETAILED DESCRIPTION

Systems, methods, and apparatuses are described herein which relate generally to various techniques related to an integrated method for designing and testing business processes. The computer-based end-to-end process modeler described herein provides a single integrated tool for designing, testing, building, and deploying a series of end-to-end business processes. A business process, in this context is much more than a process flow diagram. It comprises all the elements required for a process to be developed, executed, measured, managed, and optimized, and as such are a structured series of documented activities organized to achieve a specific business objective. The structure of a particular business process may vary by company, as there are multiple practices for executing any specific objective. Business processes, which can be comprised of multiple sub-processes, are graphically represented in flow diagrams and can span third-party applications. An end-to-end business process is a major business process for the company, one that may span multiple divisions or organizations within as well as outside the company's legal boundaries. An end-to-end business process also can involve interaction with multiple interconnected computer systems executing either autonomously or with end users. The technology described herein permits the design of such an end-to-end business process, as well as the simpler basic business processes. The technology described herein may be applied to multiple process types (e.g., management, control, support), as well as multiple roles (e.g., stockroom clerk, purchasing agent), and allows for seamless integration of these components.

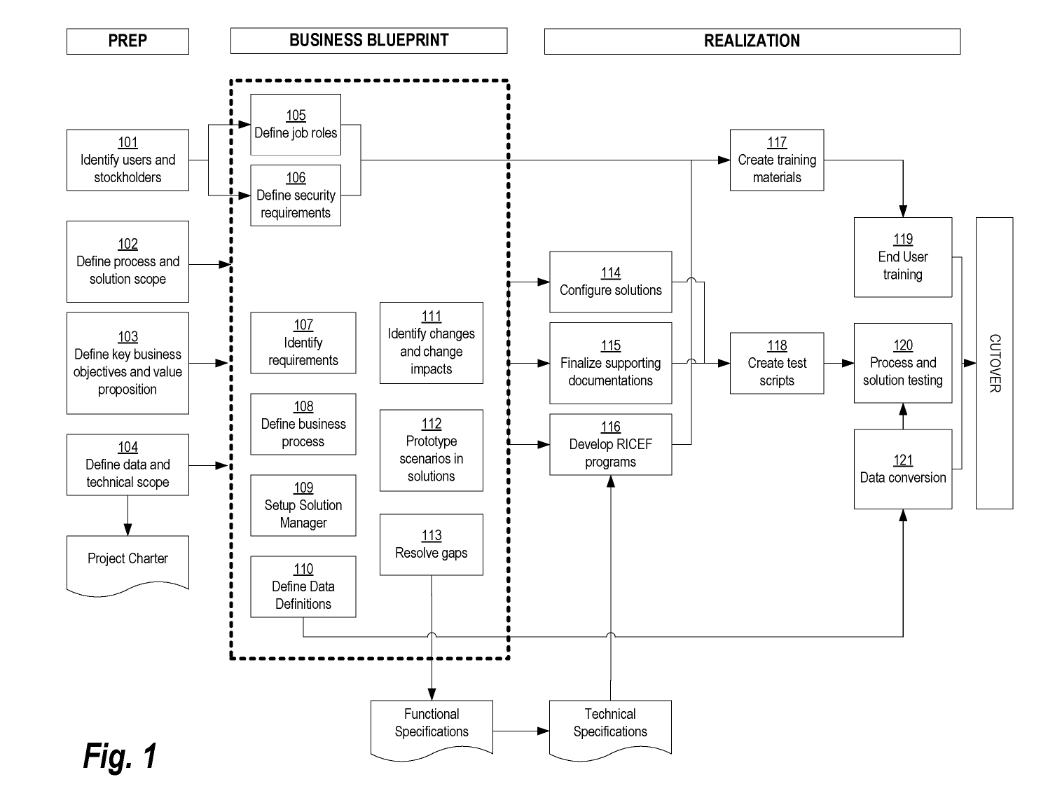

FIG. 1 is a diagram of one embodiment of a typical software implementation project. The activities in a project may vary, but in general most software projects follow these steps. The example of FIG. 1 is conceptually divided into three phases: project preparation (“prep”), business blueprint, and realization. These three phases are part of Accelerated SAP (ASAP) Methodology. The ASAP Methodology is used for implementation of SAP™ systems in business processes. Methodologies such as the ASAP Methodology are employed by project managers and others who implement systems that support business processes. It should be noted that, although the ASAP Methodology is used in the example of FIG. 1, the technology described in the present application may be similarly applied to other software and hardware implementation methodologies.

The goal of the framework illustrated in FIG. 1 is implementation of a business process model. As is generally understood in the art, a business process model may be defined using a process hierarchy. Different levels of this hierarchy provide information about the model process at different levels of granularity. In the examples provided herein, it is assumed that the process model comprises six levels. The highest level, referred to herein as Level 1, corresponds to the business area of the process being modeled. Levels 2-5 correspond to related process groups, business processes, business process variants, and process steps, respectively of the process being modeled. Finally, the lowest level, referred to herein as Level 6, corresponds to activities or actions that a user performs in order to fulfill one or more process steps specified at Level 5 of the hierarchy. This process hierarchy is generally known in the art and it is commonly adapted for implementations of the ASAP Methodology. However, it should be understood that the techniques described herein are not limited to this particular hierarchy and, in other embodiments, different types of hierarchies or other multi-level representations of the process model may be employed.

During the project preparation phases, the development performs activities related to initial planning and preparation for the project. Examples of these activities are illustrated in blocks 101-104. At block 101, the project stakeholders and business users are identified. This is typically done by conducting interviews (e.g., in person or via a web page or other graphical user interface). At block 102, the project scope is defined from a business process perspective. The solutions to support these processes are also identified. Key business objectives of the project are identified and documented at block 103. The data and technical requirements from the solution are identified at block 104.

In packaged application practices, generic software applications provided by third party vendors, for example, International Business Machines, Oracle, and SAP are customized to meet individual customer site's information technology (IT) needs. Such practice method may initially include the process of blueprinting, i.e., a design phase that determines the differences between the generic software and what is needed for the particular customer, and may also involve modifying the generic software to meet the needs of that customer.

Blocks 105-113 show the business blueprint phase of a software implementation project. During this phase, the functional specifications of the project are developed by analyzing the various requirements of the organization based on the business goals that the organization is trying to achieve. The various activities described in blocks 105-115 may be performed, for example, by a project manager and the other members of the program team. In some embodiments, these activities may be performed manually by the project team; while in other embodiments, the activities may be semi-automated or entirely automated using one or more computers.

At block 105, the job roles are defined. These roles are for the end user of the solution being implemented. The computer-based end-to-end process modeler supports the creation of roles, and also the assignment of the role to the level 6 process steps in the business process model. The data security requirements and the requirements for the selected processes in scope are identified at blocks 106 and 107, respectively. In some embodiments of the present invention, software is used to perform the capture of requirements, as well as the classification of requirements (for example, regulatory, process improvement, and support current). The requirements may be captured at level 4 of the process model.

Continuing with reference to the business blueprint phase, at block 108, the business processes are defined. These business processes are added to the process model at level 5. The process steps are added to the process model at level 6. At block 109, a SAP solution is setup. The term “SAP solution” in this context refers a particular implementation and configuration of SAP™ software products. It should be noted that block 109 only applies to SAP system implementations. For other types of software or hardware implementations, block 109 can be customized accordingly. The content of the solution manager setup is derived from the process model Level 5 and Level 6 content.

At block 110, data definitions to support the process are identified. In some embodiments, the computer-based end-to-end process modeler described herein enables the automatic capture of key data elements. The key data elements are captured at Level 4 of the process model. Changes and change impacts to the business are identified at block 111. The computer-based end-to-end process modeler supports the capture of changes and change impacts. The changes and change impacts are captured at Level 4 of the process model. Finally, at block 112, the technical solution is prototyped and, at block 113, gaps are resolved. This typically results in development efforts.

With conventional systems, blueprinting activities are performed manually by the individuals involved in the project by traditional methods such as talking to other team members, emailing, and other such communication methods to discover the specific needs of a particular site or customer and determine what documents of the generic software need to be modified. However, as discussed in further detail below, one of the primary functions of the computer-based end-to-end process modeler is automation of blueprinting.

Returning to FIG. 1, blocks 114-121 cover the realization phase. During the realization phase, the business process requirements identified during the business blueprint phase are implemented. At block 114, the software solution is setup or configured. In some embodiments, the system setup parameters are documented in the computer-based end-to-end process modeler described herein. Supporting documentation for the implemented systems is developed at block 115. In some embodiments, this documentation is stored in the computer-based end-to-end process modeler described herein. At block 116, reports, interfaces, conversions, enhancements, and forms (RICEF) elements are developed. The RICEFs may be identified and stored in the computer-based end-to-end process modeler. At block 117, training material is created. The training materials are developed from the business process model, and the process flow diagrams. Test scripts are created from the computer-based end-to-end process modeler at block 118 and end user training is delivered at block 119.

At block 120, the software solution is tested to see if it supports the original requirements captured, as well as the business processes that were designed. The test scripts created in block 118 are used here. At block 121, the data from the old software solution is converted to the new solution and cutover is performed (i.e., the new system is launched).

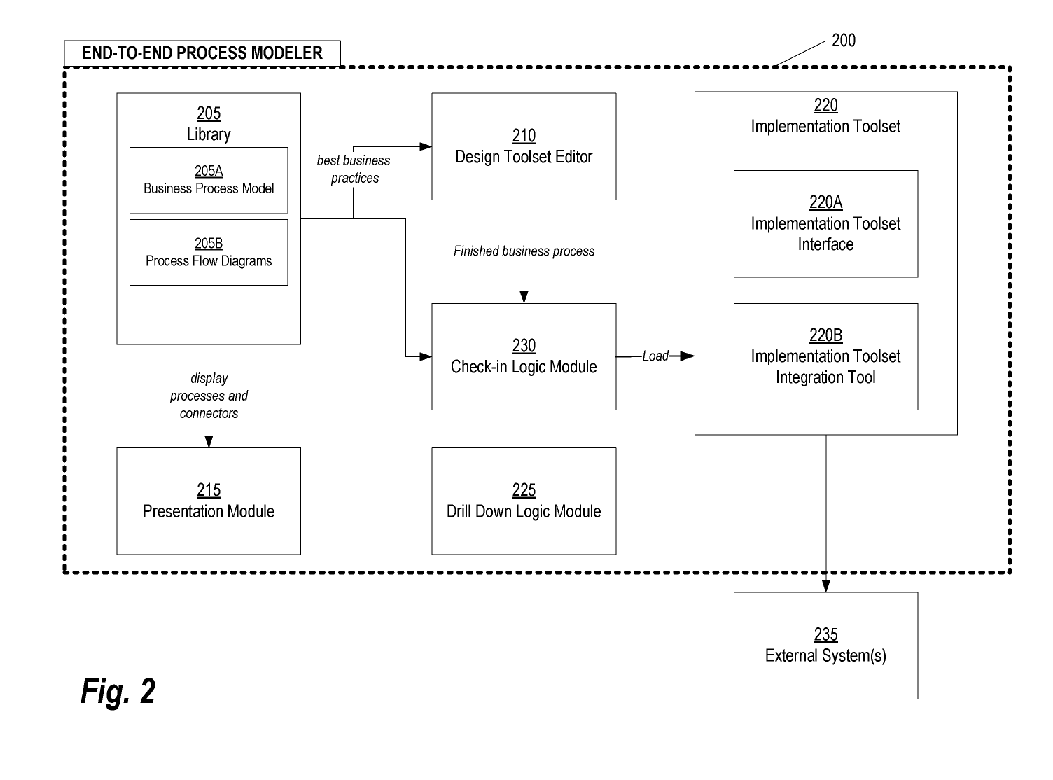

FIG. 2 illustrates a computer-based end-to-end process modeler 200, according to some embodiments. The end-to-end process modeler 200 includes a business process repository 205 comprising a plurality of predefined best practice processes. Each process in the business process repository 205 is defined in a computer-executable programming language generally known in the art. If a process is capable of automation, the code allows such automation to be directly performed by a computer. However, if user input is required by a particular process, the business process repository 205 may include additional information specified in Business Process Modeling Notation (BPMN) or a similar language for interacting with a user.

The business process repository 205 comprises a business process model 205A and process flow diagrams 205B. Conventional business process solutions do not have the capability of loading or managing a business process model. This capability requires a defined data structure that facilitates renumber of model items, etc. One improvement of the end-to-end process modeler described herein is that the process model is the core construct of our business process solution. Processes can be added to any level of the model, and automatically renumbered via the Design Toolset Editor 210 (described below). The process model content is used to develop process flow diagrams. All business process collateral can also be attached to the different levels of the business process model. Furthermore, conventional business process solutions have the capability of business users creating flow diagrams by dragging shapes from a template onto a process flow diagram canvas. The flow diagram content is thus created from scratch. With the techniques described herein, the process flow diagram canvas may be automatically populated with process activities, which are present in the business process model 205A. Process flow content is thus equal to process model content. This improvement saves customers time and money, as the time taken to document process flows is greatly reduced.

The design toolset editor 210 is a software application configured to design a business process by altering one of the plurality of best practices processes to match a business requirement. The design toolset editor 210 is configured to display processes and flow connectors as graphical objects in a graphical user interface (GUI) presented to the user. In some embodiments, the design toolset editor 210 includes predefined functionalities from the predefined best practices processes. These predefined functionalities available to the design toolset editor 210 for insertion into the business process.

In general, the design toolset editor 210 can be used to capture all content required to design a business process. This content may include, for example, role definitions, requirements, changes and change impacts, integration points, system setup documentation, data used in the process and development objects such as reports, interfaces, conversions, extensions, and forms. In some embodiments, the design toolset editor 210 also provides reporting or query capability for project managers to manage the design.

The design toolset editor 210 may also be used for specifying one or more business process support elements. Conventional business process solutions allow the linking or attachment of process collateral to the business processes. This collateral, however, has to be stored in an external document repository. The types of process collateral may also be predefined. For example, some solutions only allow policies, procedures, key performance indicators (KPIs), etc. Using the end-to-end process modeler 200, process collateral may be stored directly in the library 205, thus eliminating the need for an external document repository. The types of process collateral that may be stored is also not limited and may be defined by business users. This allows for the documentation of Business Rules, Work Instructions, SOPs, and Integration Points, but also provides reporting or query capability to list or view this collateral.

In some embodiments, the design toolset editor 210 may also include a test case generator (not shown in FIG. 2). For example, in one embodiment, this test case generator creates test cases from the design content developed in the design toolset editor 210. Test cases can be generated from requirements, business rules, and process controls. Using the test case generator, business users can create business process test cases from the business process model. The generator may allow users to select any process, and any level in the model. The test case steps may then be extracted from the process model and placed in a table for later review or analysis.

A presentation module 215 receives the instructions for generating the GUI and formats it as needed. For example, in some embodiments, the user accesses the end-to-end process modeler 200 via a web-based interface. In these instances, the presentation module 215 may format the GUI (and any related graphical interfaces) as webpages. Similarly, the presentation module 215 may format the GUI for mobile viewing and interaction if the user is on a mobile device such as a smartphone or tablet. In embodiments where the design toolset editor 210 operates within a desktop tool or some other dedicated software application, the presentation module 215 may simply manage the updating of graphical aspects of the design toolset editor 210. Techniques for implementing the presentation module 215 are generally known in the art and, for brevity, these techniques are not described in detail herein.

An implementation toolset 220 in the end-to-end process modeler 200 generates an executable process from the business process. The implementation toolset 220 comprises an implementation toolset interface 220A that implements changes to underlying code of the processes necessitated by the changes made in the design toolset editor 210. An implementation toolset integration tool 220B integrates the business process with one or more external systems 235 related to implementation of business processes within a particular organization.

A check-in logic module 230 receives the business process from the design toolset editor and to pass the business process to the implementation toolset interface for implementation. As part of the check-in process, the check-in logic module 230 analyzes the business process and flags elements that require attention during implementation. In some embodiments, the flag associated with a process signifies a type of modification to be performed during implementation.

In some embodiments, the end-to-end process modeler 200 includes drill-down logic module 225 that includes logic for “drilling down” to a sub-process and to steps of the sub-process. The phrase “drilling down” in this context means moving downward through a data hierarchy. In the context of the end-to-end modeler 200, this hierarchy is defined as the process at the top of the hierarchy and the sub-processes connected below the process in the hierarchy. Thus, the drill-down logic module 225 provides logic for parsing the hierarchy to locate particular sub-processes and understand their relationship to the process as a whole. For example, in some embodiments, the drill-down logic module 225 enables displaying and editing of the steps of the sub-process for the Design Tool Editor 210. In other embodiments, the drill-down logic module 225 may be used by one or more components of the check-in logic module or the implementation toolset 220 during process implementation.

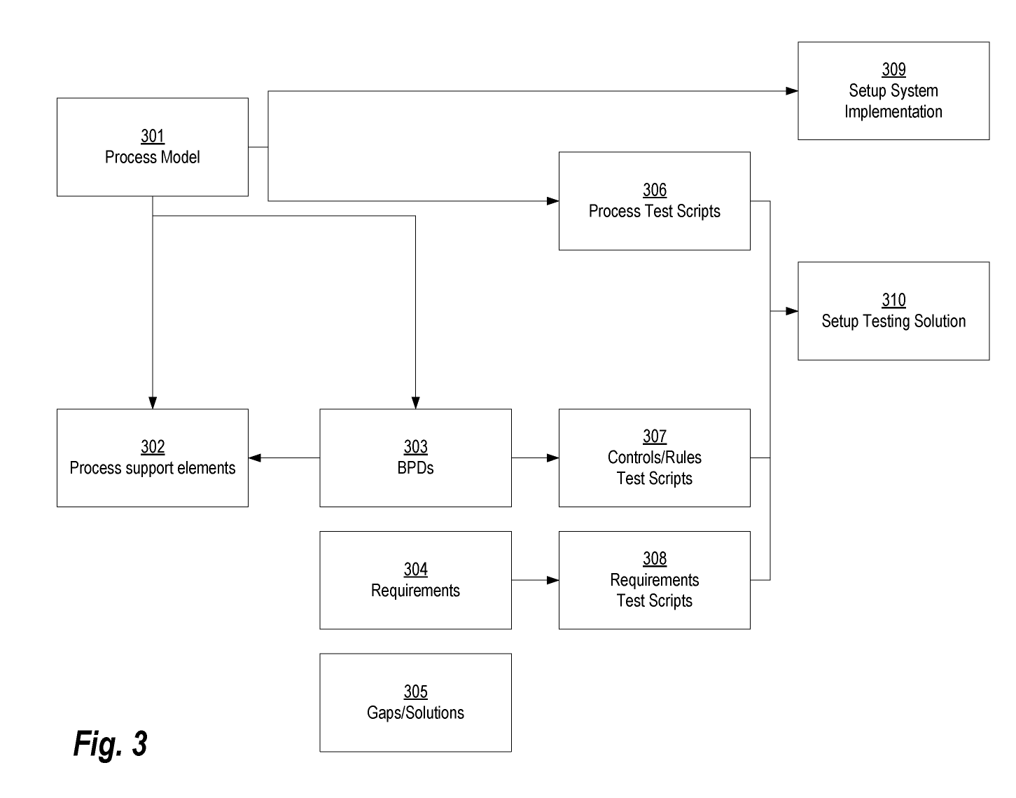

FIG. 3 is a diagram of the architecture of the computer-based end-to-end process modeler, according to some embodiments. This example shows the process model being central to the computer-based end-to-end process modeler described herein. It also shows how data can be extracted from the solution and integrated to other supporting frameworks. Starting at block 301, the process model is shown. This is the central data construct of the computer-based end-to-end process modeler described herein.

The business process support elements are developed at block 302. These support elements can either be developed in conjunction with the model, or developed from the computer-based end-to-end process modeler. At block 303, the computer-based end-to-end process modeler is launched from the process model, at the 4th node or level of the model.

The requirements for the selected processes in scope are identified at block 304. The computer-based end-to-end process modeler supports the capture of requirements, as well as the classification of requirements (for example, regulatory, process improvement, and support current). The requirements are captured at level 4 of the process design solution. At block 305, gaps and solutions for the requirements are identified.

Continuing with reference to FIG. 3, the business process test scripts are created using the model content at block 306. Processes are selected, and the test script is populated with the level 6 tasks for the selected processes. At block 307, test scripts are created using the content from the computer-based end-to-end process modeler. Test scripts are created for the controls, and business rules. At block 308, test scripts are created using the content from the computer-based end-to-end process modeler. Test scripts are created for the requirements.

A SAP solution is setup at block 309. This step is for SAP system implementations only; for other software system implementations, the setup activity performed at block 309 would be adjusted accordingly. The content of the solution manager setup is derived from the process model level 5 and level 6 content. A testing solution is setup at block 310. All the test scripts created in the computer-based end-to-end process modeler can be loaded into the testing tool.

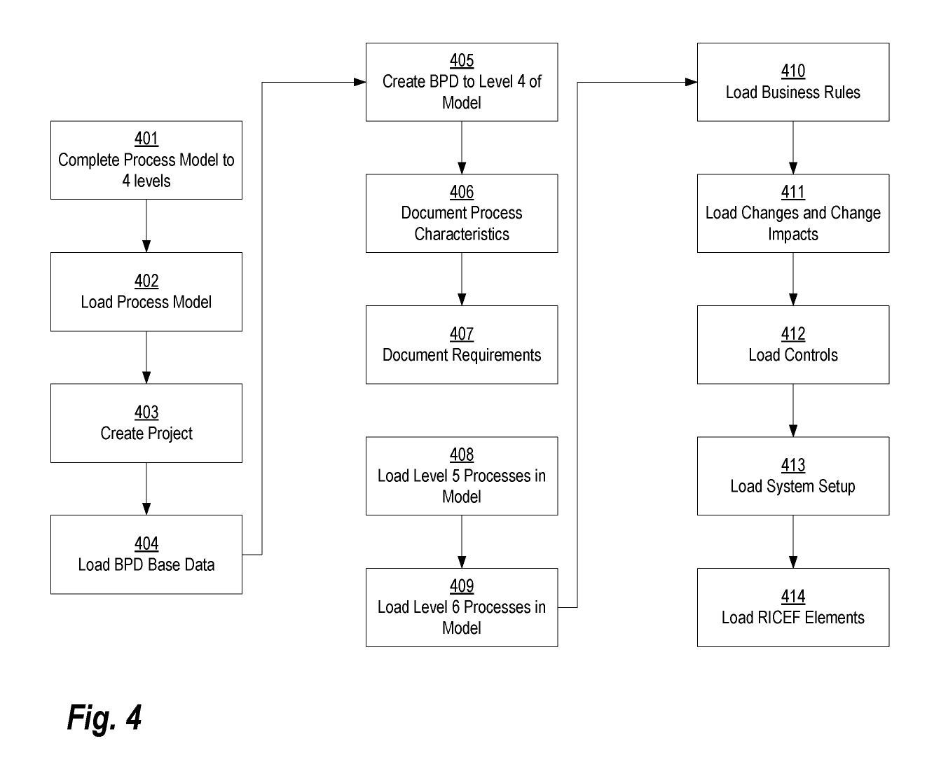

FIG. 4 is a diagram of one embodiment of the design process to be followed. This sequence of activities will allow the computer-based end-to-end process modeler to be populated completely. The business process model is developed at block 401. In some embodiments the initial model development is a manual activity and is typically performed with business users, and done by conducting interviews, or design sessions. In other embodiments, various task involved with completing the model are automated or semi-automated (e.g., using machine learning and/or past activity of the user).

The business process model is loaded into the computer-based end-to-end process modeler at block 402. The model in block 401 is imported into the computer-based end-to-end process modeler. To support importing when the business process model is generated external to the computer-based end-to-end process modeler, the solution may support importing into one or more common formats known in the art (e.g., CSV file format). Thus, the business process model first saved into the supported file format in an external tool, then the formatted business process model may be imported, for example, through an option provided in the GUI of the computer-based end-to-end process modeler.

The user creates a project at block 403, for example, by selecting a “new project” option in the computer-based end-to-end process modeler and entering basic project information (e.g., name of the project). Business process design is done within the scope of a project. Process design documents are associated with projects. As the next step of the project creation process, the computer-based end-to-end process modeler is loaded with base, or configuration data at block 404. Examples of base data include various statuses, role descriptions, project team identifiers, and project team members. The business process design documented is created at step 405. This is the data object that all other design steps will populate. Additionally, at block 406, the business process design characteristics are populated. Data such as project team and business process description may be added here.

Continuing with reference to FIG. 4, the computer-based end-to-end process modeler identifies the requirements for the selected processes in scope at block 407. In some embodiments, the computer-based end-to-end process modeler supports the capture of requirements via user input, analysis of a set of existing documents, or retrieval from a local or remote data base. The end-to-end process modeler may also support the classification of requirements (e.g., regulatory, process improvement, and support current).

The business processes to support the requirements are identified and loaded into the model at block 408. These processes are loaded in the process model at level 5. Similarly, at block 409, the process steps to support the business processes created in block 408 are identified and loaded into the model at block 409. The process steps are added to the process model at level 6. Business rules are loaded at block 410. Business processes typically have rules that help define the way they operate. An example of a rule is: all purchase orders that exceed the value of $50 must be approved by management.

At block 411 of FIG. 4, changes and change impacts to the business are identified. In some embodiments, the computer-based end-to-end process modeler captures changes and change impacts via user input or, in some embodiments, change impacts may be inferred based on other input provided by the user or processed by the computer-based end-to-end process modeler. Controls are loaded into the computer-based end-to-end process modeler at block 412. Business processes typically have controls that help an organization manage the business processes. An example of a control is: all current day orders must be closed, before the following day orders are loaded. System setup actions are identified and documented at block 413. Finally, at block 414, reports, interfaces, conversions, enhancements, and forms (RICEF) elements are developed. Technical and functional specifications for the solution can also be loaded at block 414.

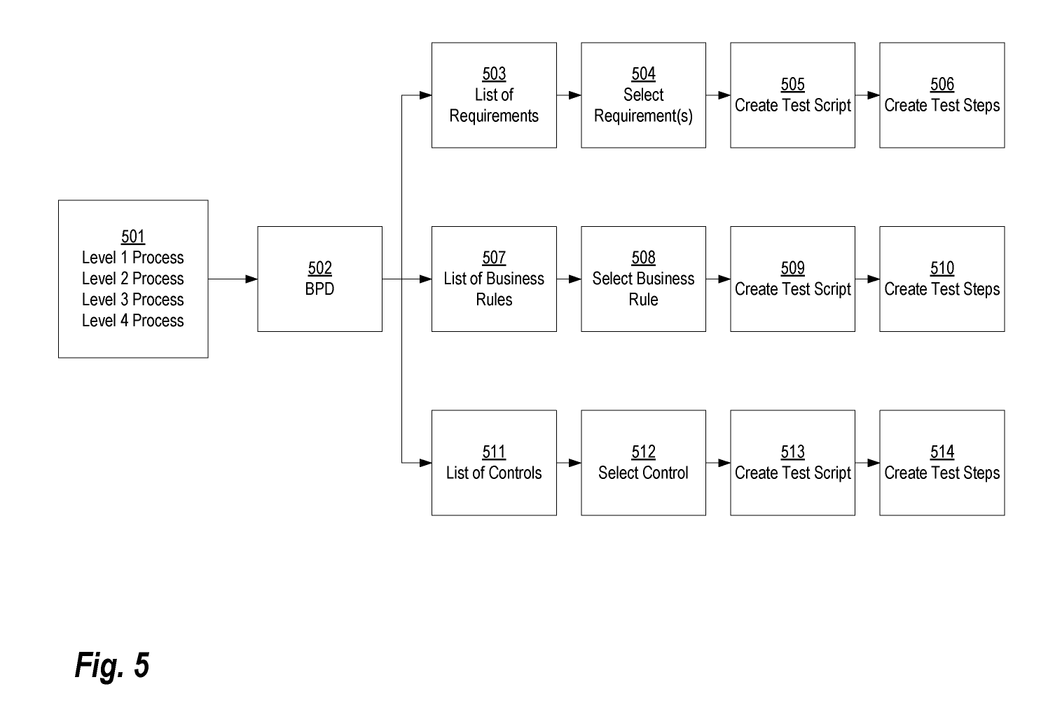

FIG. 5 is a flowchart of one embodiment of the process to follow for creating test scripts from the design content. Starting at block 501, the business process model is shown with 5 levels of processes. This is the central data construct of the computer-based end-to-end process modeler.

At block 502, the business process design document is shown. These documents are created at level 5 of the business process model. The list requirements are shown at step 503. The gathering of requirements is essential to any project. Here we want to ensure that all requirements that have been approved will have solutions, and will be tested. Individual requirements are selected for test script creation at step 504, and test scripts for requirements are created at step 505. These scripts have an identifier, a status, and a test description. At block 506, test actions to complete the test are loaded into the test script created in block 505.

The list of business rules generated from the business process design document is shown at block 507. It is essential to ensure the business rules are tested. Here we want to ensure that all business rules will have solutions, and will be tested. Individual business rules are selected for test script creation at block 508. At block 509, test scripts for business rules are created. These scripts have an identifier, a status, and a test description. Finally, at block 510, test actions to complete the test are loaded into the test script created in block 55.

The list of controls generated from the business process design document is shown at block 511. It is essential to ensure the controls are tested. Here we want to ensure that all controls will have solutions, and will be tested. At block 512, individual controls are selected, for test script creation. Test scripts for controls are created at block 513. These scripts have an identifier, a status, and a test description. At block 514, test actions to complete the test are loaded into the test script created in block 505.

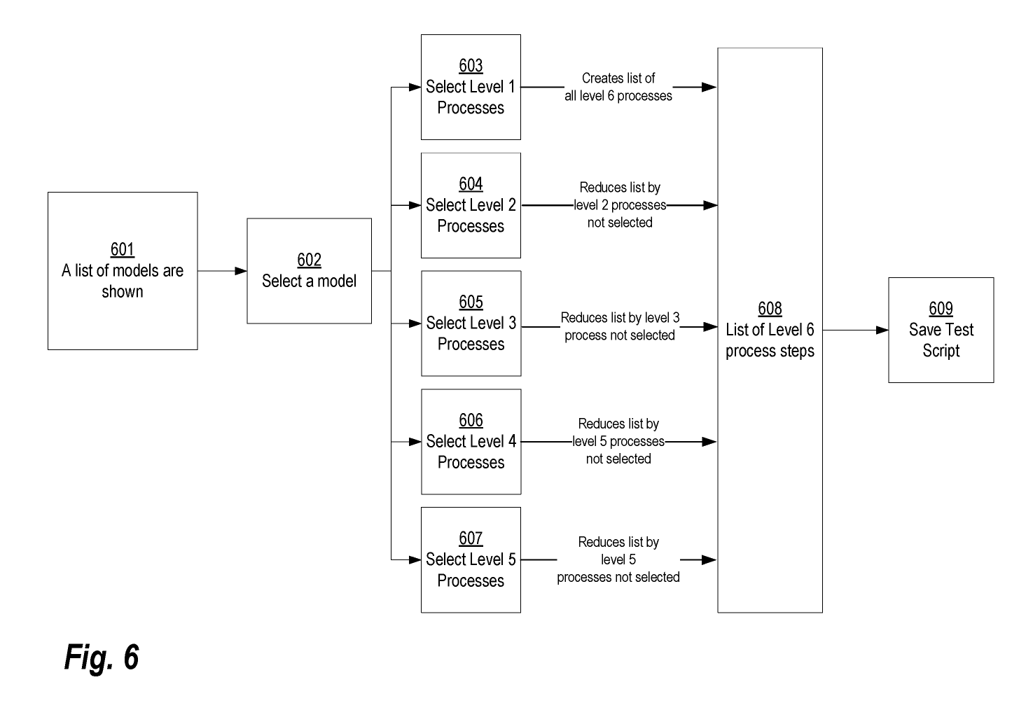

FIG. 6 is a flowchart of one embodiment of the process to follow for creating test scripts from the process model. Starting at block 601, the computer-based end-to-end process modeler presents a list of process models to a test script developer. Test scripts are developed within the context of a process model. At block 602, the test script developer selects the process model from the list shown in block 601.

At block 603, the test script developer sees the Level 1 processes of the process model selected in block 602. Level 1 processes are then selected for testing. One or multiple Level 1 processes can be selected. Once the Level 1 processes are selected, all the Level 6 process steps, for the selected Level 1 processes are added to a testing list. This testing list is shown in block 608.

At block 604, the test script developer sees the Level 2 processes of the Level 1 processes selected in block 603. Level 2 processes are then deselected from testing. One or multiple Level 2 processes can be deselected. Once the Level 2 processes are deselected, the Level 6 process steps, for the deselected Level 2 processes are removed from the testing list. This testing list is shown in block 608.

At block 605, the test script developer sees the Level 3 processes of the Level 2 processes selected in block 603. Level 3 processes are then deselected from testing. One or multiple Level 3 processes can be deselected. Once the Level 3 processes are deselected, the Level 6 process steps, for the deselected Level 3 processes are removed from the testing list. This testing list is shown in block 608.

At block 606, the test script developer see the Level 4 processes of the Level 3 processes selected in block 603. Level 4 processes are then deselected from testing. One or multiple Level 4 processes can be deselected. Once the Level 4 processes are deselected, the Level 6 process steps, for the deselected Level 4 processes are removed from the testing list. This testing list is shown in block 608.

At block 607, the test script developer sees the Level 5 processes of the Level 4 processes selected in block 603. Level 6 processes are then deselected from testing. One or multiple Level 6 processes can be deselected. Once the Level 6 processes are deselected, the Level 6 process steps, for the deselected Level 6 processes are removed from the testing list. This testing list is shown in block 608.

The testing list is shown in the computer-based end-to-end process modeler at step 608. The content of the testing list is the Level 6 process steps that were not deselected from blocks 603 to 607. This is the test list created for the test script. At block 609, the test script is saved. The testing selections from blocks 603 through 607 are saved, as well as the final list of process steps in block 608.

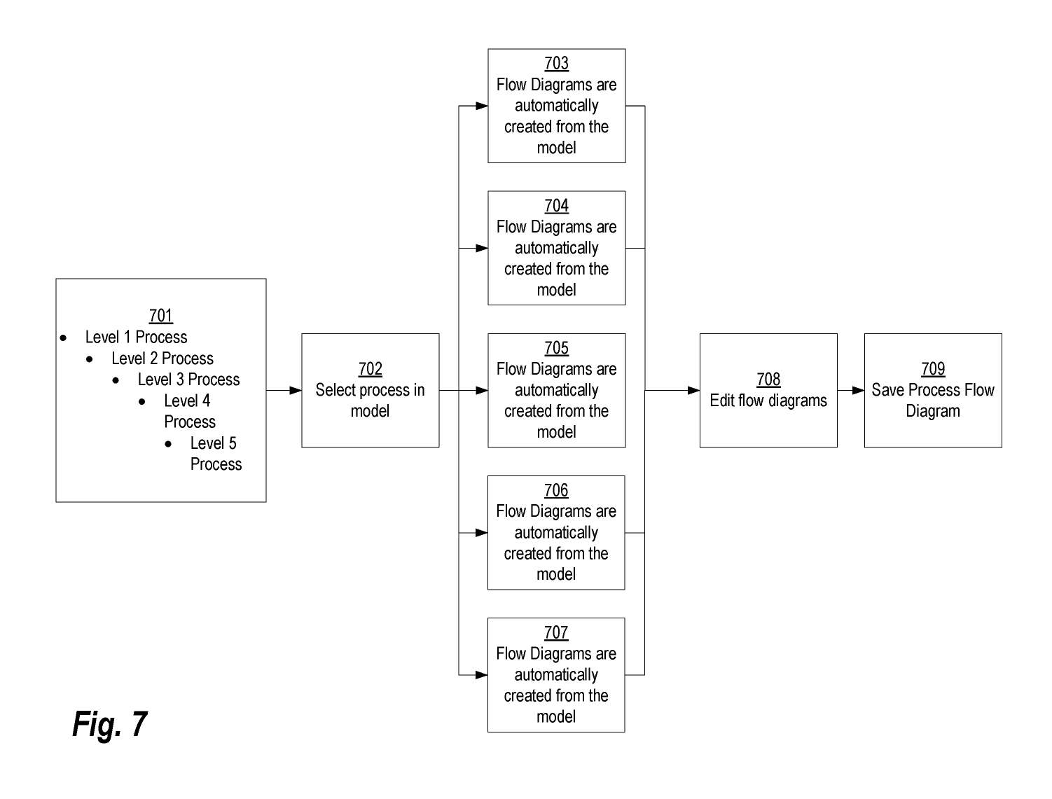

FIG. 7 illustrates one embodiment of the automatic creation of a process flow diagram from the process model. Starting at block 701, the computer-based end-to-end process modeler presents a list of process models to a test script developer. Test scripts are developed within the context of a process model. At block 702, the test script developer selects the process model from the list shown in block 701.

At block 703, the process developer reviews the Level 1 processes of the process model. A Level 1 process is then selected by clicking on it. Once the Level 1 process is selected, the Level 2 processes for the selected Level 1 process are shown in the process flow diagram section of the screen. The Level 2 processes are shown in the form of a rectangle. These Level 2 processes are generated automatically from the process model.

At block 704, processes for Level 2 processes of the process model can be automatically generated by selecting a Level 2 process. Once the Level 2 process is selected, the Level 3 processes for the selected Level 2 process are shown in the process flow diagram section of the screen. The Level 3 processes are shown in the form of a rectangle.

At block 705, processes for Level 3 processes of the process model can be automatically generated by selecting a Level 3 process. Once the Level 3 process is selected, the Level 4 processes for the selected Level 3 process are shown in the process flow diagram section of the screen. The Level 4 processes are shown in the form of a rectangle.

At block 706, processes for Level 4 processes of the process model can be automatically generated by selecting a Level 4 process. Once the Level 4 process is selected, the Level 5 processes for the selected Level 4 process are shown in the process flow diagram section of the screen. The Level 5 processes are shown in the form of a rectangle.

At block 707, processes for Level 5 processes of the process model can be automatically generated by selecting a Level 5 process. Once the Level 5 process is selected, the Level 6 process steps for the selected Level 5 process are shown in the process flow diagram section of the screen. The Level 6 process steps are shown in the form of a rectangle.

The process flow diagrams generated in blocks 703 through 707 are optionally edited in the computer-based end-to-end process modeler at block 708. For example, in some embodiments, flow diagram rectangles can be moved, extra text and symbols can be also be added. At block 709, the process flow diagrams generated in blocks 703 through 707 (and optionally edited at block 708), can be saved via the computer-based end-to-end process modeler.

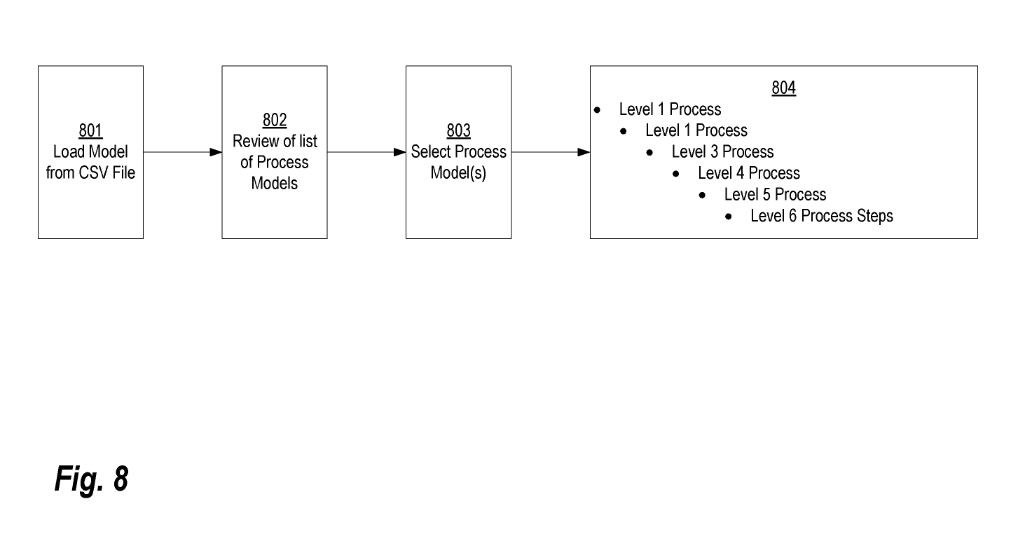

FIG. 8 illustrates one embodiment of how multiple process models are loaded from an external data source. Starting at block 801, the process model is loaded into the computer-based end-to-end process modeler, for example from a CSV formatted file. The computer-based end-to-end process modeler can store multiple models. Large organizations with different Lines of Business (LOB) may have a different model for each LOB.

Continuing with reference to FIG. 8, at block 802, the process developer will see a list of process models that are loaded into the computer-based end-to-end process modeler. Next, at block 803, the process developer selects the process model from the list shown in block 802. As shown at block 804, each model contains up to 6 levels of process details.

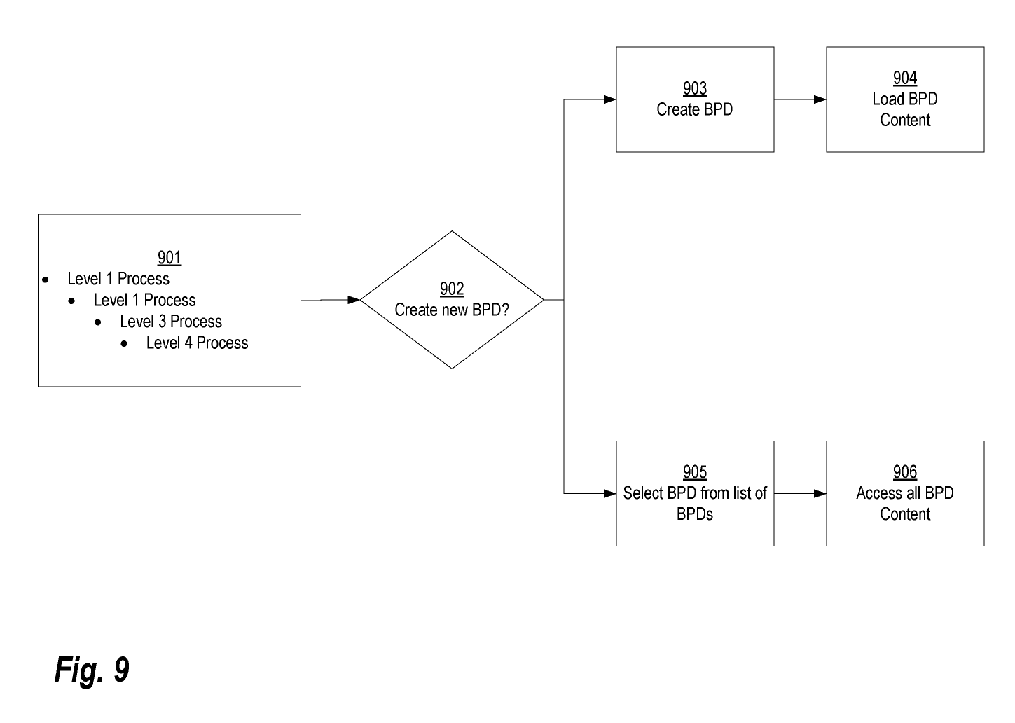

FIG. 9 illustrates embodiments of how multiple design documents are created at level 4 of the process model. Starting at block 901, the process developer interacts with the computer-based end-to-end process modeler to navigate through the process model to level 4. Next, at block 902, the process developer decides if a new business process definition (BPD) is required or whether an existing BPD will be accessed. If a new BPD needs to be created, the computer-based end-to-end process modeler creates the BPD at step 903 using the process discussed below with respect to FIG. 9. This BPD is then loaded into the current project by the computer-based end-to-end process modeler at block 904. If the BPD does not need to be created, the process developer can select an existing BPD at block 905. Once loaded, the BPD content can be accessed via the computer-based end-to-end process modeler at block 906.

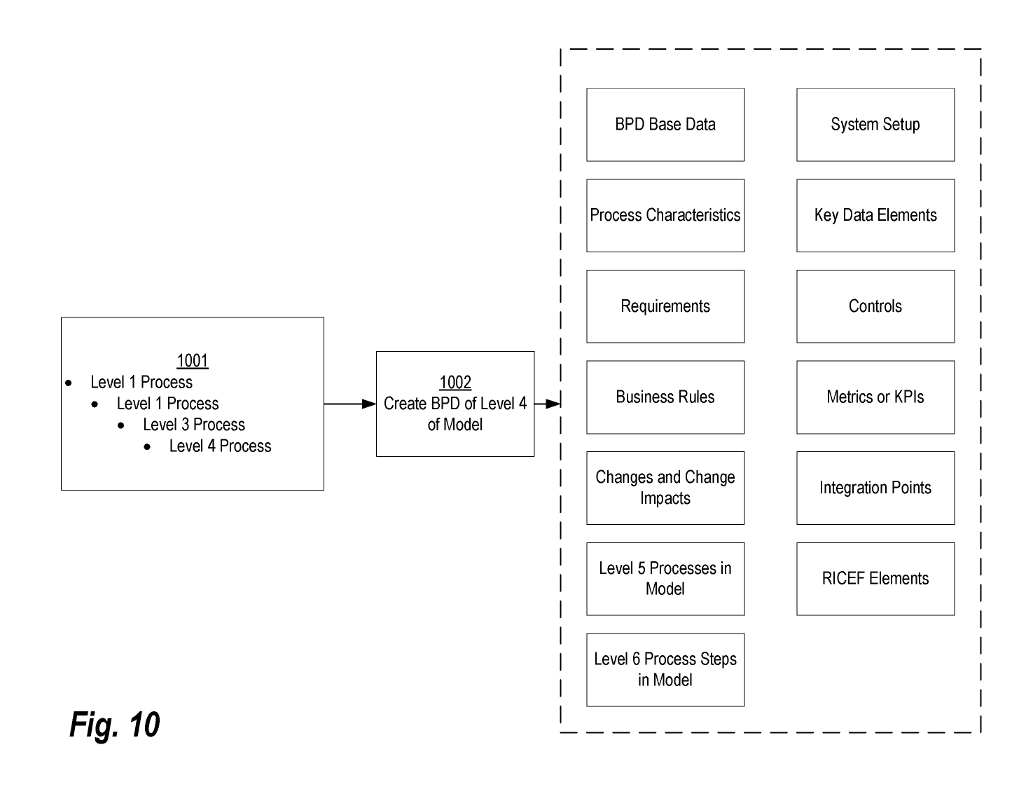

FIG. 10 illustrates all the design elements that must be completed during the design phase of a software implementation. Starting at block 1001, the process developer navigates through the process model to level 4. Next, in this example, the process developer decides a new BPD is required, and a BPD is created at block 1002. Finally, the process developer inputs process data into the computer-based end-to-end process modeler. In this example, the process data includes base data (e.g., project id, and sponsor), process characteristics (e.g., inputs, outputs, triggers, etc.), requirements, business rules, changes and change impacts, Level 5 processes, Level 6 process steps, system setup parameters, key data elements, controls, metrics or KPIs, integration points, and RICEF elements.

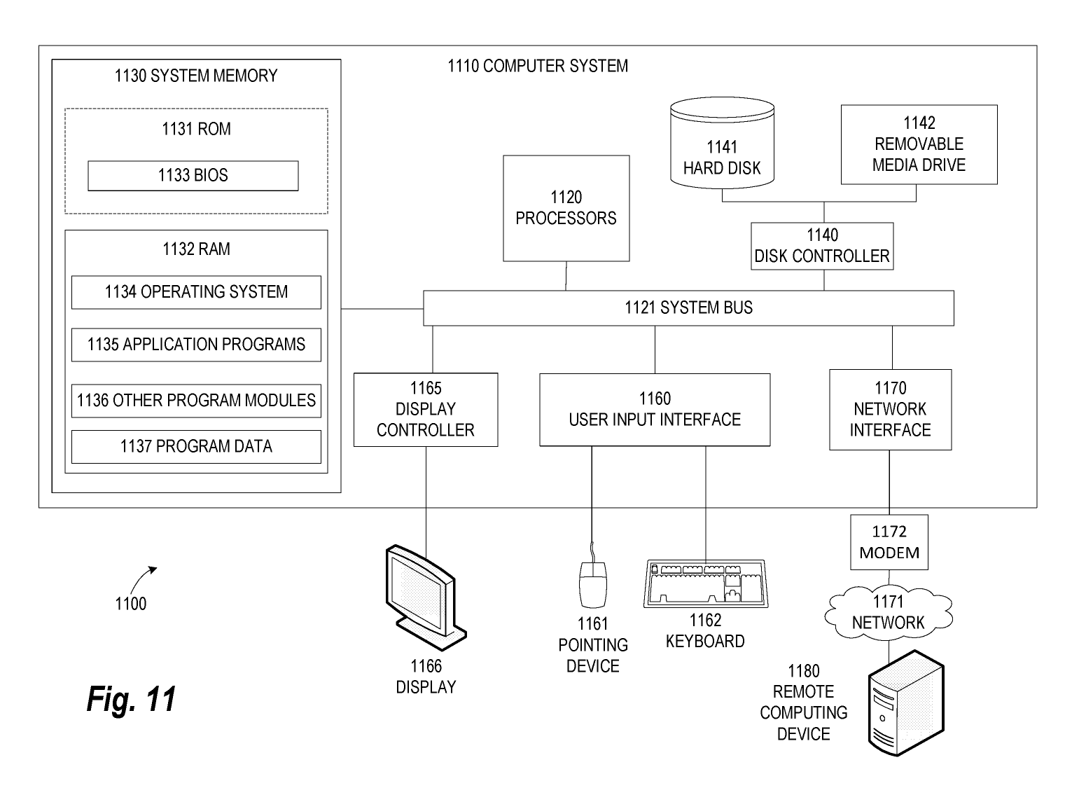

FIG. 11 illustrates an exemplary computing environment 1100 within which embodiments of the invention may be implemented. For example, this computing environment 1100 may be used to implement one or more of the components illustrated in the end-to-end process modeler 200 described in FIG. 2. The computing environment 1100 may include computer system 1110, which is one example of a computing system upon which embodiments of the invention may be implemented. Computers and computing environments, such as computer system 1110 and computing environment 1100, are known to those of skill in the art and thus are described briefly here.

As shown in FIG. 11, the computer system 1110 may include a communication mechanism such as a bus 1121 or other communication mechanism for communicating information within the computer system 1110. The computer system 1110 further includes one or more processors 1120 coupled with the bus 1121 for processing the information. The processors 1120 may include one or more central processing units (CPUs), graphical processing units (GPUs), or any other processor known in the art.

The computer system 1110 also includes a system memory 1130 coupled to the bus 1121 for storing information and instructions to be executed by processors 1120. The system memory 1130 may include computer readable storage media in the form of volatile and/or nonvolatile memory, such as read only memory (ROM) 1131 and/or random access memory (RAM) 1132. The system memory RAM 1132 may include other dynamic storage device(s) (e.g., dynamic RAM, static RAM, and synchronous DRAM). The system memory ROM 1131 may include other static storage device(s) (e.g., programmable ROM, erasable PROM, and electrically erasable PROM). In addition, the system memory 1130 may be used for storing temporary variables or other intermediate information during the execution of instructions by the processors 1120. A basic input/output system (BIOS) 1133 containing the basic routines that help to transfer information between elements within computer system 1110, such as during start-up, may be stored in ROM 1131. RAM 1132 may contain data and/or program modules that are immediately accessible to and/or presently being operated on by the processors 1120. System memory 1130 may additionally include, for example, operating system 1134, application programs 1135, other program modules 1136, and program data 1137.

The computer system 1110 also includes a disk controller 1140 coupled to the bus 1121 to control one or more storage devices for storing information and instructions, such as a hard disk 1141 and a removable media drive 1142 (e.g., floppy disk drive, compact disc drive, tape drive, and/or solid state drive). The storage devices may be added to the computer system 1110 using an appropriate device interface (e.g., a small computer system interface (SCSI), integrated device electronics (IDE), Universal Serial Bus (USB), or FireWire).

The computer system 1110 may also include a display controller 1165 coupled to the bus 1121 to control a display 1166, such as a cathode ray tube (CRT) or liquid crystal display (LCD), for displaying information to a computer user. The computer system includes an input interface 1160 and one or more input devices, such as a keyboard 1162 and a pointing device 1161, for interacting with a computer user and providing information to the processor 1120. The pointing device 1161, for example, may be a mouse, a trackball, or a pointing stick for communicating direction information and command selections to the processor 1120 and for controlling cursor movement on the display 1166. The display 1166 may provide a touch screen interface which allows input to supplement or replace the communication of direction information and command selections by the pointing device 1161.

The computer system 1110 may perform a portion or all of the processing steps of embodiments of the invention in response to the processors 1120 executing one or more sequences of one or more instructions contained in a memory, such as the system memory 1130. Such instructions may be read into the system memory 1130 from another computer readable medium, such as a hard disk 1141 or a removable media drive 1142. The hard disk 1141 may contain one or more datastores and data files used by embodiments of the present invention. Datastore contents and data files may be encrypted to improve security. The processors 1120 may also be employed in a multi-processing arrangement to execute the one or more sequences of instructions contained in system memory 1130. In alternative embodiments, hard-wired circuitry may be used in place of or in combination with software instructions. Thus, embodiments are not limited to any specific combination of hardware circuitry and software.

As stated above, the computer system 1110 may include at least one computer readable medium or memory for holding instructions programmed according to embodiments of the invention and for containing data structures, tables, records, or other data described herein. The term “computer readable medium” as used herein refers to any medium that participates in providing instructions to the processor 1120 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 1141 or removable media drive 1142. Non-limiting examples of volatile media include dynamic memory, such as system memory 1130. Non-limiting examples of transmission media include coaxial cables, copper wire, and fiber optics, including the wires that make up the bus 1121. Transmission media may also take the form of acoustic or light waves, such as those generated during radio wave and infrared data communications.

The computing environment 1100 may further include the computer system 1110 operating in a networked environment using logical connections to one or more remote computers, such as remote computer 1180. Remote computer 1180 may be a personal computer (laptop or desktop), a mobile device, a server, a router, a network PC, a peer device or other common network node, and typically includes many or all of the elements described above relative to computer system 1110. When used in a networking environment, computer system 1110 may include modem 1172 for establishing communications over a network 1171, such as the Internet. Modem 1172 may be connected to bus 1121 via user network interface 1170, or via another appropriate mechanism.

Network 1171 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 1110 and other computers (e.g., remote computer 1180). The network 1171 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 1171.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112(f) unless the element is expressly recited using the phrase “means for.”

We claim:

1. A system for performing end-to-end process modeling, the system comprising:
a business process repository comprising a plurality of predefined best practice processes;
a design toolset editor configured to design a business process by altering one of the plurality of best practices processes to match a business requirement, wherein the design toolset editor is configured to display processes and flow connectors as graphical objects; and
an implementation toolset configured to generate an executable process from the business process and comprising an implementation toolset interface configured to enable implementation of changes to underlying code of the processes necessitated by the changes made in the design toolset editor.

2. The system of claim 1, wherein the design toolset editor further includes predefined functionalities from the plurality of predefined best practices processes, the predefined functionalities available to the design toolset editor for insertion into the business process.

3. The system of claim 1 further comprising:
an implementation toolset integration tool configured to integrate the business process with an external system.

4. The system of claim 1, further comprising:
a drill-down logic module configured to drill down to a sub-process and to steps of the sub-process, wherein said drilling down enables displaying and editing of the steps of the sub-process.

5. The system of claim 1, further comprising:
a check-in logic module configured to receive the business process from the design toolset editor and to pass the business process to the implementation toolset interface for implementation.

6. The system of claim 5, further comprising:
a flagging logic module configured to flag one or more elements in the business process that require attention during implementation.

7. The system of claim 6, wherein the flag signifies a type of modification to be performed during implementation.

8. The system of claim 5, further comprising:
a collection of processes in progress available to the implementation toolset interface for editing, wherein the collection of processes comprises completed business processes finished using the design toolset editor.

9. A computer-implemented method for performing end-to-end process modeling, the method comprising:
retrieving a business process model associated with a predefined best practice process from a business process repository;
displaying the business process model in an interactive graphical user interface;
modifying the business process model via the graphical user interface based on one or more business requirements; and
generating a computer-executable process from the modified business process model.

10. The method of claim 9, wherein modifying the business process model includes adding one or more new processes to the business process model.

11. The method of claim 10, wherein the one or more new processes are added between one or more numbered processes in the business process model and the method further comprises:
following addition of the one or more new processes, renumbering all processes in the business process model.

12. The method of claim 9, wherein the business process model comprises a plurality of levels and modifying the business process model includes attaching business process collateral elements to one or more of the levels.

13. The method of claim 12, further comprising:
storing the business process collateral elements in the business process repository.

14. The method of claim 13, further comprising:
receiving a request for listing of business process collateral elements associated with a particular business process;
querying the business process repository to retrieve the listing of business process collateral elements associated with the particular business process; and
presenting a graphical representation of the listing of business process collateral elements in response to the request.

15. The method of claim 9, further comprising:
determining one or more process activities included in the business process model;
populating a flow diagram canvas based on the one or more process activities;
displaying the flow diagram canvas in the graphical user interface; and
creating one or more process flow diagrams based on user interaction with the flow diagram canvas via the graphical user interface.

16. A system for performing end-to-end process modeling, the system comprising:
a business process repository comprising a plurality of business process models;
a process design module presenting one or more graphical user interface for modifying the business process models; and
a test case generator creating business process test cases from the business process models.

17. The system of claim 16, wherein each business process model comprises a plurality of levels and modifying the business process model includes attaching business process collateral elements to one or more of the levels.

18. The system of claim 17, wherein the business process collateral elements are stored in the business process repository.

19. The system of claim 16, wherein the business process test cases comprise one or more tables and the test case generator extracts test case steps from the business process models in the tables.
